(19) United States
(12) Patent Application Publication
(10) Pub. No.: US 2023/0394241 A1
(43) Pub. Date: Dec. 7, 2023

(54) SYSTEM AND METHOD FOR BRIDGING GRAPHICS AND LINGUISTICS

(71) Applicant: THE REGENTS OF THE UNIVERSITY OF CALIFORNIA, Oakland, CA (US)

(72) Inventor: Haijun Xia, San Diego, CA (US)

(21) Appl. No.: 18/032,123

(22) PCT Filed: Oct. 14, 2021
(86) PCT No.: PCT/US2021/055058

§ 371 Date: Apr. 14, 2023

Related U.S. Application Data
(60) Provisional application No. 63/092,442, filed on Oct. 15, 2020.

(51) Int. Cl. G06F 40/30; G06T 11/00; G06F 40/253; G10L 21/10

(52) U.S. Cl. CPC G06F 40/30; G06T 11/00; G06F 40/253; G10L 21/10; G06T 2200/24

(57) ABSTRACT

A computer system for generating graphics content receives text or information specifying an amount of spoken language and uses NLP to extract linguistic structures associated with the text or the amount of spoken language to determine mappings between the linguistic structures and the graphics content based at least in part on a predefined grammar. The predefined grammar may specify a target context for matching to arguments associated with the linguistic structures and may specify one or more corresponding graphics elements having associated appearances, layouts and/or graphics effects. The computer system then generates the graphics content associated with the text or the amount of spoken language.

### RELATED APPLICATIONS

This application claims priority under 35 U.S.C. 119(e) to U.S. Provisional Application No. 63/092,442, filed on Oct. 15, 2020, the contents of which are herein incorporated by reference.

### FIELD OF THE INVENTION

The described embodiments relate to a system and method for identifying and extracting linguistic structures in language, including syntactic, semantic, and coreference structures. More specifically, the described embodiments relate to a method for selecting linguistic structure in language to invoke graphics templates.

### BACKGROUND

Today, graphics content, such as videos, animations, and presentations, can be produced at increasingly fast speeds thanks to the proliferation of computer-aided design applications. The user interfaces found within these applications typically follow the principles of direct manipulation, allowing content creators to directly manipulate and configure graphics elements. Some existing approaches us machine-learning techniques to create graphics content, mostly three-dimensional (3D) models, from text input. However, these machine-learning techniques often require highly descriptive text and usually do not allow the users to customize and adjust the generated results.

Consequently, creating and editing graphics content usually is a laborious process because content creators must manually configure a multitude of image properties to achieve even the simplest graphics layout or animation. This time-consuming and repetitive process is frustrating for users and limits their ability to be creative and to express themselves.

### SUMMARY

A computer system that generates graphics content is described. This computer may include: a computation device (such as a processor, a graphics processing unit or GPU, etc.) that executes program instructions; and memory that stores the program instructions. During operation, the computer system receives text or information specifying an amount of spoken language. Then, the computer system extracts, using natural language processing (NLP), linguistic structures associated with the text or the amount of spoken language. Moreover, the computer system determines mappings between the linguistic structures and the graphics content based at least in part on a predefined grammar, where the predefined grammar specifies a target context for matching to arguments associated with the linguistic structures, and specifies one or more corresponding graphics elements having one or more associated: appearances, layouts and/or graphics effects, which may include, but is not limited to, animations. Next, the computer system generates the graphics content associated with the text or the amount of spoken language, wherein the graphics content comprises a graphics element having: an appearance, a layout and/or a graphics effect.

Note that the mappings may be determined based at least in part on user-specified mappings between the linguistic structures and the graphics. For example, the computer system may receive user-interface activity specifying the user-specified mappings, and the user-interface activity may correspond to dynamic interaction, via a user interface, of a user with at least a subset of the linguistic structures, at least a subset of the graphics, or both to specify at least a subset of the graphics content.

Moreover, the computer system may: perform a search for the one or more graphics elements based at least in part on a search query corresponding to the user-interface activity and/or the determined linguistic structures. For example, the search may include an image search.

Furthermore, the computer system may provide a presentation with the text or the amount of spoken language and the graphics content.

Additionally, the NLP may include a pretrained: neural network, or a machine-learning model (such as a machine-learning model trained using a supervised-learning technique and/or an unsupervised-learning technique).

In some embodiments, the linguistic structures include: a syntactic structure that specifies a rule governing an order of words; a semantic structure that specifies a meaning or interpretation of one or more of the words, a phrase the comprises one or more of the words, or a sentence that comprises one or more of the words; a coreference that indicates multiple words or phrases corresponding to a common entity; and/or an organizational list specifying a paragraph, a section or a heading. For example, the syntactic structure may include or may specify dependencies or relationships among the words. Moreover, organization of one or more of the graphics elements may be based at least in part on the semantic structure. Furthermore, the semantic structure may specify the appearance, the layout or the graphic effect of the graphics element. Note that the graphics element may be an added graphics element or a modified graphics element in the graphics content. Alternatively, the semantic structure may specify removal of a second graphics element from the graphics content. Additionally, a common graphics element may be associated with the multiple words or phrases for the coreference.

Moreover, the computer system may provide a recommendation for one or more graphics elements based at least in part on the user-interface activity.

Furthermore, the user-interface activity may include connecting a first linguistic structure and a second linguistic structure so that one or more graphics elements associated with the first linguistic structure specify at least a portion of the predefined grammar for the second linguistic structure.

An additional function that may be included in the user-interface activity include navigating the many linguistic structures to allow the user to select the desired linguistic structures. Another function within the user-interface activity may be modifying the linguistic structures to refine and adjust the corresponding graphic elements, as well as their appearance, layout, and graphic effects.

Another embodiment provides a computer-readable storage medium for use with the computer system. When executed by the computer system, this computer-readable storage medium causes the computer system to perform at least some of the aforementioned operations.

Another embodiment provides a method, which may be performed by the computer system. This method includes at least some of the aforementioned operations.

This Summary is provided for purposes of illustrating some exemplary embodiments, so as to provide a basic understanding of some aspects of the subject matter described herein. Accordingly, it will be appreciated that the above-described features are examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE FIGURES

FIG. 1 is a drawing illustrating an example of text and associated images in accordance with an embodiment of the present disclosure.

FIG. 2 is a block diagram illustrating an example of a computer system in accordance with an embodiment of the present disclosure.

FIG. 3 is a flow diagram illustrating an example of a method for generating graphics content using a computer system in FIG. 2 in accordance with an embodiment of the present disclosure.

FIG. 4 is a drawing illustrating an example of communication between components in a computer system in FIG. 2 in accordance with an embodiment of the present disclosure.

FIG. 5 is a drawing illustrating example diagrams of syntactic structure, semantic structure, and coreference structure found in a script about photography in accordance with an embodiment of the present disclosure.

FIG. 6 is a drawing illustrating an example of a language-driven grammar in accordance with an embodiment of the present disclosure.

FIG. 7 is a drawing illustrating an example of suggested structures in language in accordance with an embodiment of the present disclosure.

FIG. 8 is a drawing illustrating an example of flexible composition of graphical representation in accordance with an embodiment of the present disclosure.

FIG. 9 is a drawing illustrating an example of a user interface in accordance with an embodiment of the present disclosure.

FIG. 10 is a drawing illustrating an example workflow in accordance with an embodiment of the present disclosure.

FIG. 11 is a drawing illustrating feedback responses from participants in accordance with an embodiment of the present disclosure.

FIG. 12 is a block diagram illustrating an example of a computer in accordance with an embodiment of the present disclosure.

Note that like reference numerals refer to corresponding parts throughout the drawings. Moreover, multiple instances of the same part are designated by a common prefix separated from an instance number by a dash.

### DETAILED DESCRIPTION OF EMBODIMENTS

A computer system that generates graphics content is described. This computer may include: a computation device (such as a processor, a graphics processing unit or GPU, etc.) that executes program instructions; and memory that stores the program instructions. During operation, the computer system may receive text or information specifying an amount of spoken language. Then, the computer system may extract, using NLP, linguistic structures associated with the text or the amount of spoken language. Moreover, the computer system may determine mappings between the linguistic structures and the graphics content based at least in part on a predefined grammar, where the predefined grammar may specify a target context for matching to arguments associated with the linguistic structures, and may specify one or more corresponding graphics elements having one or more associated: appearances, layouts and/or graphics effects. For purposes of this description, graphic effects may include, but are not limited to one or more animations. Next, the computer system may generate the graphics content associated with the text or the amount of spoken language, wherein the graphics content comprises a graphics element having: an appearance, a layout and/or a graphics effect.

By generating the graphics content, the graphics techniques may facilitate the creation of a presentation or an animation. Notably, the graphics techniques may allow a user to dynamically interact with the linguistic structures via a user interface to navigate, select, modify and connect the linguistic structures. Then, based at least in part on the predefined grammar, the computer system may automatically generate the graphics content for the presentation or animation. Moreover, the computer system may perform searches for one or more graphics elements and/or may provide recommendations for one or more graphics elements based at least in part on the user interaction and/or the determined linguistic structures. Consequently, the graphics techniques may reduce the time and effort needed to create the presentation. Therefore, the graphics techniques may: improve the user experience, reduce user frustration, and/or facilitate improved communication and creativity.

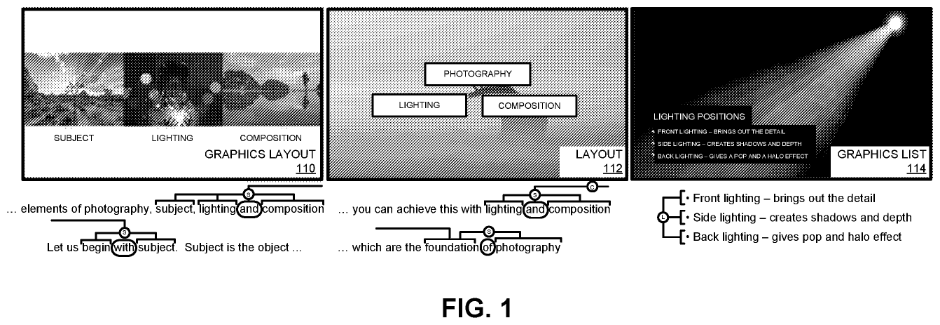

As shown in FIG. 1, which presents a drawing illustrating an example of text and associated images, imagine if you were a photographer making a tutorial video and this was the first sentence of your script, “Today, I will talk about three key elements of photography: subject, lighting, and composition . . . . Let's begin with the subject.” In order to design animations to accompany this script, you may want to have images representing subject, lighting, and composition appear one by one, and then the image of the main element, subject, to be highlighted. Furthermore, in order to do this, you typically would need to: manually find the images of the mentioned elements online; copy these images into a digital canvas; resize and crop each image to the same dimensions; align the images on the canvas; create an ‘appear’ animation for each image; and create a ‘highlight’ animation for the subject image.

While creating this video segment is time-consuming and tedious, the video segment uses images and graphics effects to enhance engagement and to facilitate viewer comprehension. Notably, you took specific care to ensure the layout, ordering, and animations in the segment correspond to the content in the script, e.g., the images of the elements that are resized and aligned on screen are direct mappings of the “subjects, lighting, and composition” conjunction phrase that is in the script and the order in which the images “appear” is informed by the order that the element occurs within the phrase. Similarly, the highlight animation corresponds to the phrase “begin with”, whose semantics suggests a transitional action and provides direction about the order in which you wish content to change.

This correspondences between the visual artifacts on the screen and the script that you had prepared is an example of the Congruence Principle, which has been recommended for effective visual communication: the content and format of the graphics should correspond to the content and format of the concepts to be conveyed. It also demonstrates how the syntax and semantics found within language can be used for language-oriented authoring to inform graphics content that will be created.

Imagine if a content creation system could automatically provide templates informed by the syntax and semantics within a script, where images are automatically resized and aligned, and transition animations to be added whenever “begin with” or similar phrases are encountered. Such abstracted and encapsulated functionality would allow users to directly indicate their high-level design goals once, in a form that is more natural to them than manually performing a series of tedious low-level editing operations.

While research has been exploring the use of natural language input to create graphics content (e.g., 3D scenes), these existing graphics techniques typically focus on the literal conversion of highly descriptive, domain-specific language. Furthermore, the pursuit of fully automated processes inherently makes the linguistic elements of the language inaccessible for further customization or editing. In the disclosed interactive graphics techniques, language-oriented authoring is described, e.g., leveraging the latent structures inherent in language to facilitate automated creation and manipulation of graphics content. These capabilities allow users to directly interact with the linguistic structures (which are sometimes referred to as ‘language structures’) to specify the graphics structures.

Notably, despite existing direct manipulation techniques available in computer-aided design applications, creating digital content remains a tedious and indirect task. This is because applications often require users to perform numerous low-level editing operations, rather than allowing them to directly indicate high-level design goals. Nonetheless, the creation of graphics content, such as videos, animations, and/or presentations, often begins with a description of design goals in natural language, such as screenplays, scripts, outlines. Therefore, there is an opportunity for language-oriented authoring, e.g., leveraging the information found in the structure of a language to facilitate the creation of graphics content. In the disclosed interactive graphics techniques, identification, graphics description, and interaction with various linguistic structures are used to assist in the creation of visual content. The disclosed system (which is sometimes referred to as “Crosspower”), and its proposed interaction techniques, enable content creators to indicate and customize their desired visual content in a flexible and direct manner.

In the discussion that follows, we explore the linguistic and organizational structures that can be extracted from written content with Natural Language Processing (NLP). Moreover, we define a language-driven grammar that describes these structures using visual layouts and animations. Furthermore, we design interaction techniques that enable content creators to access and leverage these structures while creating graphics content.

These approaches enable users to select the linguistic structure from the language to invoke the graphics templates. Once a corresponding graphics template is provided, the users can modify the linguistic structures, which results in changes in the corresponding graphics template. The users can also combine different linguistic structures to compose complicated graphics layouts and animations that are tedious to create with existing applications. Relevant textual information may also be used to search and query corresponding visual content. In some embodiments, the users can manually create the correspondence between the linguistic and graphics elements for future reuse.

As noted previously, in order to leverage the utility of language-oriented authoring, Crosspower was developed. Crosspower supports users in quickly navigating, selecting, modifying, and combining the structures in language to compose and adjust graphics layouts and animations. Moreover, interaction techniques that were designed to complement Crosspower can significantly reduce manual effort during graphics content creation, while enabling rapid and flexible customization. Thus, as shown in FIG. 1, with Crosspower a user can directly interact with the linguistic and organizational structures in a script or outline and use them to create graphics elements and compose graphics effects. Notably, Crosspower provides: a graphics layout 110 indicated by syntactic conjunction structure; a layout 112 indicated by the ‘foundation’ semantic structure; and a graphics list 114 indicated by list structure in the script.

The capabilities provided by Crosspower can be broadly applied to videos, animations, presentations, and other media, as the production of such content, despite their visual basis, often begins in a written form (e.g., as a screenplay, script, or outline). Written language allows visual content creators to communicate ideas, concepts, and stories, but also plan, prepare, and prototype visual forms, with minimal costs. Crosspower leverages the precedent role of language in existing creation processes and provides additional capabilities with language. The results of an expert evaluation of Crosspower demonstrate that the use of language structures with the proposed interaction techniques enabled users to easily indicate and customize visual content. Potential applications of the disclosed interactive graphics techniques include: presentations, animation, video editing, and visual augmentation of natural conversation (e.g., using augmented reality or virtual reality).

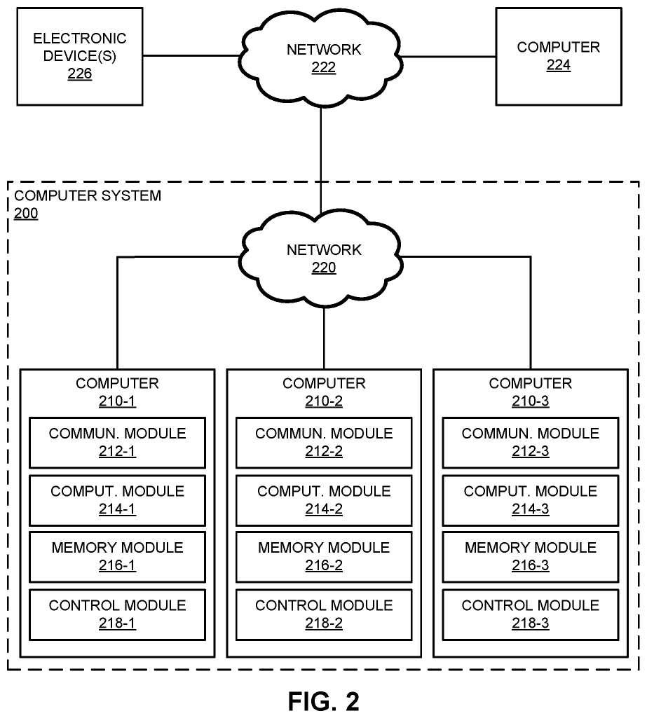

FIG. 2 presents a block diagram illustrating an example of a computer system 200 that implements the interactive graphics techniques. This computer system may include one or more computers 210. These computers may include: communication modules 212, computation modules 214, memory modules 216, and optional control modules 218. Note that a given module or engine may be implemented in hardware and/or in software.

Communication modules 212 may communicate frames or packets with data or information (such as content, e.g., text, audio and/or video, or control instructions) between computers 210 via a network 220 (such as the Internet and/or an intranet). For example, this communication may use a wired communication protocol, such as an Institute of Electrical and Electronics Engineers (IEEE) 802.3 standard (which is sometimes referred to as ‘Ethernet’) and/or another type of wired interface. Alternatively or additionally, communication modules 212 may communicate the data or the information using a wireless communication protocol, such as: an IEEE 802.11 standard (which is sometimes referred to as ‘Wi-Fi’, from the Wi-Fi Alliance of Austin, Texas), Bluetooth (from the Bluetooth Special Interest Group of Kirkland, Washington), a third generation or 3G communication protocol, a fourth generation or 4G communication protocol, e.g., Long Term Evolution or LTE (from the 3rd Generation Partnership Project of Sophia Antipolis, Valbonne, France), LTE Advanced (LTE-A), a fifth generation or 5G communication protocol, other present or future developed advanced cellular communication protocol, or another type of wireless interface. For example, an IEEE 802.11 standard may include one or more of: IEEE 802.11a, IEEE 802.11b, IEEE 802.11g, IEEE 802.11-2007, IEEE 802.11n, IEEE 802.11-2012, IEEE 802.11-2016, IEEE 802.11ac, IEEE 802.11ax, IEEE 802.11ba, IEEE 802.11be, or other present or future developed IEEE 802.11 technologies.

In the described embodiments, processing a packet or a frame in a given one of computers 210 (such as computer 210-1) may include: receiving the signals with a packet or the frame; decoding/extracting the packet or the frame from the received signals to acquire the packet or the frame; and processing the packet or the frame to determine information contained in the payload of the packet or the frame. Note that the communication in FIG. 2 may be characterized by a variety of performance metrics, such as: a data rate for successful communication (which is sometimes referred to as ‘throughput’), an error rate (such as a retry or resend rate), a mean squared error of equalized signals relative to an equalization target, intersymbol interference, multipath interference, a signal-to-noise ratio, a width of an eye pattern, a ratio of number of bytes successfully communicated during a time interval (such as 1-10 s) to an estimated maximum number of bytes that can be communicated in the time interval (the latter of which is sometimes referred to as the ‘capacity’ of a communication channel or link), and/or a ratio of an actual data rate to an estimated data rate (which is sometimes referred to as ‘utilization’). Note that wireless communication between components in FIG. 2 uses one or more bands of frequencies, such as: 900 MHz, 2.4 GHz, 5 GHz, 6 GHz, 60 GHz, the Citizens Broadband Radio Spectrum or CBRS (e.g., a frequency band near 3.5 GHz), and/or a band of frequencies used by LTE or another cellular-telephone communication protocol or a data communication protocol. In some embodiments, the communication between the components may use multi-user transmission (such as orthogonal frequency division multiple access or OFDMA).

Moreover, computation modules 214 may perform computations using: one or more microprocessors, ASICs, microcontrollers, programmable-logic devices, GPUs and/or one or more digital signal processors (DSPs). Note that a given computation component is sometimes referred to as a ‘computation device’.

Furthermore, memory modules 216 may access stored data or information in memory that local in computer system 200 and/or that is remotely located from computer system 200. Notably, in some embodiments, one or more of memory modules 216 may access stored content, graphics and/or images in the local memory. Alternatively or additionally, in other embodiments, one or more memory modules 216 may access, via one or more of communication modules 212, stored content, graphics and/or images in the remote memory in computer 224, e.g., via network 220 and network 222. Note that network 222 may include: the Internet and/or an intranet. In some embodiments, the content, graphics and/or images are received from one or more electronic devices 226 via network 220 and network 222 and one or more of communication modules 212. Thus, in some embodiments at least some of the content, graphics and/or images may have been received previously and may be stored in memory, while in other embodiments at least some of the content, graphics and/or images may be received in real-time from the one or more electronic devices 226.

While FIG. 2 illustrates computer system 200 at a particular location, in other embodiments at least a portion of computer system 200 is implemented at more than one location. Thus, in some embodiments, computer system 200 is implemented in a centralized manner, while in other embodiments at least a portion of computer system 200 is implemented in a distributed manner. For example, in some embodiments, the one or more electronic devices 226 may include local hardware and/or software that performs at least some of the operations in the interactive graphics techniques.

Although we describe the computation environment shown in FIG. 2 as an example, in alternative embodiments, different numbers or types of components may be present in computer system 200. For example, some embodiments may include more or fewer components, a different component, and/or components may be combined into a single component, and/or a single component may be divided into two or more components.

As discussed previously, existing graphics techniques often require repetitive manual configuration by users. This process is tedious and time-consuming, which frustrates users and limits their ability to communicate information and, thus, their creativity.

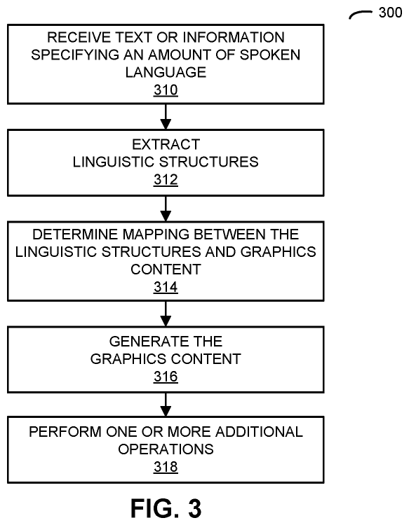

Moreover, as described further below with reference to FIGS. 3-11, in order to address these challenges computer system 200 may perform the interactive graphics techniques. Notably, during the interactive graphics techniques, one or more of optional control modules 218 may divide operations among computers 210. Then, a given computer (such as computer 210-1) may perform at least a designated portion of the analysis. Notably, computation module 214-1 may receive (e.g., access) information (e.g., using memory module 216-1) specifying content, graphics and/or images associated with one or more individuals.

For example, computation module 214-1 may receive, via communication module 212-1, text or information specifying an amount of spoken language (e.g., audio and/or video) from computer 224 and/or one of electronic devices 224. Alternatively or additionally, computation module 214-1 may access the text or the information specifying the amount of spoken language using memory module 216-1.

Then, computation module 214-1 may perform additional operations in the interactive graphics techniques. For example, computation module 214-1 may extract, using NLP, linguistic structures associated with the text or the amount of spoken language. Note that the NLP may include a pretrained: neural network, or a machine-learning model (such as a machine-learning model trained using a supervised-learning technique and/or an unsupervised-learning technique).

In some embodiments, the linguistic structures include: a syntactic structure that specifies a rule governing an order of words; a semantic structure that specifies a meaning or interpretation of one or more of the words, a phrase the comprises one or more of the words, or a sentence that comprises one or more of the words; a coreference that indicates multiple words or phrases corresponding to a common entity; and/or an organizational structure specifying a paragraph, a section, a heading, or a list. For example, the syntactic structure may include or may specify dependencies or relationships among the words. Moreover, organization of one or more of the graphics elements may be based at least in part on the semantic structure. Furthermore, the semantic structure may specify the appearance, the layout or the graphic effect of the graphics element. Note that the graphics element may be an added graphics element or a modified graphics element in the graphics content. Alternatively, the semantic structure may specify removal of a second graphics element from the graphics content. Additionally, a common graphics element may be associated with the multiple words or phrases for the coreference.

Moreover, computation module 214-1 may determine mappings between the linguistic structures and graphics content based at least in part on a predefined grammar, where the predefined grammar may specify a target context for matching to arguments associated with the linguistic structures, and may specify one or more corresponding graphics elements having one or more associated: appearances, layouts and/or graphics effects. Alternatively or additionally, note that the mappings may be determined based at least in part on user-specified mappings between the linguistic structures and the graphics. For example, computation module 214-1 may receive, via communication module 212-1, user-interface activity specifying the user-specified mappings from computer 224 and/or one of electronic devices 224, and the user-interface activity may correspond to dynamic interaction, via a user interface, of a user with at least a subset of the linguistic structures and/or at least a subset of the graphics to specify at least a subset of the graphics content. In some embodiments, the user-interface activity may include connecting a first linguistic structure and a second linguistic structure so that one or more graphics elements associated with the first linguistic structure specify at least a portion of the predefined grammar for the second linguistic structure. In some embodiments, the user-interface activity may include the additional function of navigating the many linguistic structures to allow the user to select the desired linguistic structures. Still another function within the user-interface activity may include modifying the linguistic structures to refine and adjust the corresponding graphic elements, as well as their appearance, layout, and graphic effects.

Note that computation module 214-1 may optionally: perform a search for the one or more graphics elements based at least in part on a search query corresponding to the user-interface activity and/or the determined linguistic structures. For example, the search may include an image search. Furthermore, computation module 214-1 may provide, via communication module 212-1, a recommendation for one or more graphics elements based at least in part on the user-interface activity to computer 224 and/or one of electronic devices 224. This may allow the user to optionally select, via the user interface, the one or more graphics elements for use in the graphics content. An additional function that may be included in the user-interface activity involves navigating the many linguistic structures to allow the user to select the desired linguistic structures. Still another function within the user-interface activity may be modifying the linguistic structures to refine and adjust the corresponding graphic elements, as well as their appearance, layout, and graphic effects.

Next, computation module 214-1 may generate the graphics content associated with the text or the amount of spoken language, wherein the graphics content comprises a graphics element having: an appearance, a layout and/or a graphics effect.

Moreover, computation module 214-1 may provide, via communication module 212-1 a presentation with the text or the amount of spoken language and the graphics content to computer 224 and/or one of electronic devices 224. Alternatively or additionally, computation module 212-1 may store the graphics content and/or the presentation using memory module 216-1. In some embodiments, computation module 214-1 may display the graphics content and/or the presentation on a display (not shown) in or associated with computer system 200.

In these ways, computer system 200 may facilitate the creation of the graphics content and/or the presentation. In the process, the graphics techniques may reduce the time and effort needed to create the presentation. Therefore, the graphics techniques may: improve the user experience, reduce user frustration, and/or facilitate improved communication and creativity.

While the preceding discussion illustrated the interactive graphics techniques using a local or a remote computer system (such as a cloud-based computer system), in other embodiments at least some of the operations in the interactive graphics techniques may be performed locally: such as by: an application installed and executing in an environment (such as an operating system) of a computer (such as computer 224) or an electronic device (such as one of electronic devices 226); an application that executed in a Web-browser (such as a Web-browser plugin); or a client-server architecture. Moreover, in general, the interactive graphics techniques may be implemented by one or more computers. In embodiments with multiple computers that implement the interactive graphics techniques, the computers may be located at the same location or different locations. Consequently, the interactive graphics techniques may be implemented in a centralized or a distributed manner.

We now describe embodiments of the method. FIG. 3 presents a flow diagram illustrating an example of a method 300 for generating graphics content, which may be performed by a computer system (such as computer system 200 in FIG. 2). During operation, the computer system may receive text (such as written words) or information specifying an amount of spoken language (operation 310).

Then, the computer system may extract, using NLP, linguistic structures (operation 312) associated with the text or the amount of spoken language. For example, the NLP may include a pretrained: neural network, or a machine-learning model (such as a machine-learning model trained using a supervised-learning technique and/or an unsupervised-learning technique).

In some embodiments, the linguistic structures include: a syntactic structure that specifies a rule governing an order of words; a semantic structure that specifies a meaning or interpretation of one or more of the words, a phrase the comprises one or more of the words, or a sentence that comprises one or more of the words; a coreference that indicates multiple words or phrases corresponding to a common entity; and/or an organizational list specifying a paragraph, a section or a heading. For example, the syntactic structure may include or may specify dependencies or relationships among the words. Moreover, organization of one or more of the graphics elements may be based at least in part on the semantic structure. Furthermore, the semantic structure may specify the appearance, the layout or the graphic effect of the graphics element. Note that the graphics element may be an added graphics element or a modified graphics element in the graphics content. Alternatively, the semantic structure may specify removal of a second graphics element from the graphics content. Additionally, a common graphics element may be associated with the multiple words or phrases for the coreference.

Moreover, the computer system may determine mappings between the linguistic structures and the graphics content (operation 314) based at least in part on a predefined grammar, where the predefined grammar may specify a target context for matching to arguments associated with the linguistic structures, and may specify one or more corresponding graphics elements having one or more associated: appearances, layouts and/or graphics effects. Next, the computer system may generate the graphics content (operation 316) associated with the text or the amount of spoken language, wherein the graphics content comprises a graphics element having: an appearance, a layout and/or a graphics effect.

In some embodiments, the computer system may optionally perform one or more additional operations (operation 318). For example, the mappings may be determined based at least in part on user-specified mappings between the linguistic structures and the graphics. Notably, the computer system may receive user-interface activity specifying the user-specified mappings, and the user-interface activity may correspond to dynamic interaction, via a user interface, of a user with at least a subset of the linguistic structures, at least a subset of the graphics, or both to specify at least a subset of the graphics content. Note that the user-interface activity may include connecting a first linguistic structure and a second linguistic structure so that one or more graphics elements associated with the first linguistic structure specify at least a portion of the predefined grammar for the second linguistic structure.

Moreover, the computer system may: perform a search for the one or more graphics elements based at least in part on a search query corresponding to the user-interface activity and/or the determined linguistic structures. For example, the search may include an image search.

Furthermore, the computer system may provide a recommendation for one or more graphics elements based at least in part on the user-interface activity.

Additionally, the computer system may provide a presentation with the text or the amount of spoken language and the graphics content.

In some embodiments of method 300, there may be additional or fewer operations. Furthermore, the order of the operations may be changed, and/or two or more operations may be combined into a single operation.

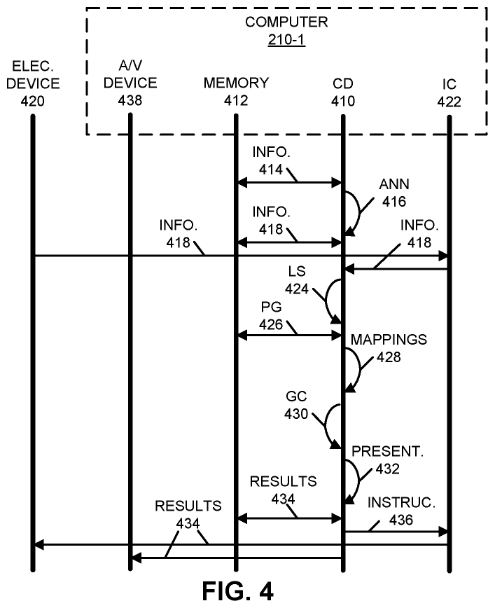

Embodiments of the interactive graphics techniques are further illustrated in FIG. 4, which presents a drawing illustrating an example of communication among components in computer system 200. In FIG. 4, a computation device (CD) 410 (such as a processor or a GPU) in computer 210-1 may access, in memory 412 in computer 210-1, information 414 specifying configuration instructions (and parameters), and hyperparameters for one or more predetermined or pretrained models, such as one or more neural networks (NNs) 416 that perform NLP. After receiving the configuration instructions and the hyperparameters, computation device 410 may implement the one or more neural networks 416.

Moreover, computation device 410 may access in memory 412 information 418 specifying content, graphics and/or images associated with at least an individual. For example, information 418 may include text or information specifying an amount of spoken language. Alternatively or additionally, electronic device 420 may provide information 418 to computer 210-1. After receiving information 418, interface circuit (IC) 422 in computer 210-1 to computation device 410.

Then, computation device 410 may extract, using NLP, linguistic structures (LS) 424 associated with the text or the amount of spoken language. Moreover, computation device 410 may determine mappings 428 between linguistic structures 424 and graphics content (GC) 430 based at least in part on a predefined grammar (PG) 426 (which are accessed in memory 412). Note that the predefined grammar may specify a target context for matching to arguments associated with the linguistic structures, and may specify one or more corresponding graphics elements having one or more associated: appearances, layouts and/or graphics effects.

Next, computation device 410 may generate graphics content 430 associated with the text or the amount of spoken language, wherein the graphics content comprises a graphics element having: an appearance, a layout and/or a graphics effect. Moreover, computation device 410 may optionally create a presentation 432 that includes graphic content 430.

After or while performing the computations, computation device 410 may store results 434, such as graphics content 430 and/or presentation 432, in memory 412. Alternatively or additionally, computation device 410 may instruct 436 interface circuit 422 to provide results 434 to electronic device 420. In some embodiments, computation device 410 may display or output results 434 on audio/visual (A/V) device 438, such as: a display, a speaker(s), headphones, an augment-reality (AR) device and/or a virtual-reality (VR) device.

While FIG. 4 illustrates communication between components using unidirectional or bidirectional communication with lines having single arrows or double arrows, in general the communication in a given operation in this figure may involve unidirectional or bidirectional communication.

We now further describe the interactive graphics techniques. The interactive graphics techniques may leverage latent structures in language and enable users to flexibly and directly articulate high-level design goals by interacting with new interface elements. Notably, by leveraging the structures inherent in language, Crosspower may significantly reduce the manual effort required to create effective and congruent visual content. In order to provide these capabilities, Crosspower may incorporate or include identification of linguistic structures. For example, in order to leverage the latent structures in language, Crosspower may use preidentified linguistic structures that can inform the creation of meaningful graphics templates and operations. Alternatively or additionally, Crosspower may extract linguistic structures from text using NLP techniques, such as a pretrained neural network (such as deep learning), a pretrained machine-learning model (such as a supervised-learning technique or an unsupervised-learning technique), and/or another type of NLP model. Moreover, Crosspower may incorporate or include specification of linguistic-graphics mappings. Notably, in order to create graphics content via linguistic structures, Crosspower may incorporate or include specifications as to how the various linguistic components can inform the creation of graphics content and intended effects. For example, Crosspower may use a language-driven grammar that specifies the graphics representations of a linguistic structure. Furthermore, Crosspower may incorporate or include interaction with linguistic and graphics structures. For example, Crosspower may use a set of interaction techniques that enable users to directly interact with language structures and their graphics correspondences to quickly and flexibly create desired graphics effects.

The creation of a comprehensive data structure or database of mappings between linguistic structures and graphics effects, e.g., a de facto visual dictionary, can enable a wide range of applications. However, constructing such a large-scale data structure or database often requires significant costs. Therefore, in some embodiments, Crosspower uses a small predefined data structure or database of, e.g., 152 linguistic structure templates. Crosspower may be implemented as a Web-application with mouse and keyboard input. Moreover, crosspower may use, e.g., three NLP models or toolkits to extract various linguistic structures because of the differences in availability, stability, and performance of different language parsing modules. Notably, the Google NLP toolkit (from Alphabet, Inc., of Mountain View, California), CogCompNLP toolkit (from the University of Pennsylvania, of Philadelphia, Pennsylvania), and Stanford NLP toolkit (from Stanford University, of Stanford, California) may be used to extract syntactic, semantic, and coreference structures. Note that time-aligned script may be acquired using a forced alignment approach.

### Identification of Structures in Language:

A language is a structured communication system that follows a grammar or set of combinatory rules to convey intent and meaning. The most basic elements of any language are morphemes (e.g., dog, eat, -s, -ing, etc.). When combined, morphemes form words (e.g., dogs, eating, etc.), which can then be further combined into phrases, clauses, and sentences (e.g., The dogs were eating), and then discourse. The syntax of a language dictates the allowable order in which words can be combined into sentences. However, the semantics of a language describe the meaning or interpretation of words, phrases, and sentences, and discourse. Visual organizational structures, such as paragraphs and sections, are used in written language to visually organize semantics.

The goal of Crosspower is to leverage the structures in language that can indicate high-level graphics relationships in order to ease the creation of graphics content. Crosspower may be based at least in part on linguistic structures, such as syntactic, semantic, and coreference structures, as well as commonly used organizational structures (such as sections and lists).

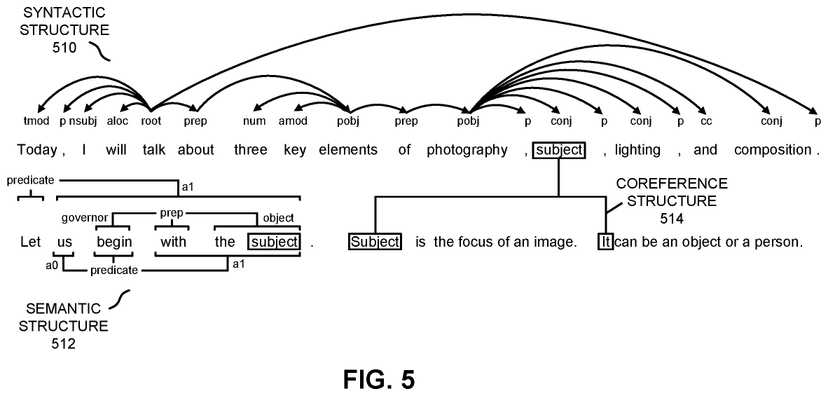

Syntactic structures (which are sometimes referred to as ‘grammars’) are low-level linguistic rules that govern the combination of words within a sentence, without giving reference to their meaning, e.g., how adjectives can describe nouns or adverbs can describe verbs. One common syntactic structure used in NLP is the dependency structure, which describes the syntactic relationship between words using binary asymmetric relations, wherein every word is associated with one dependee. This is illustrated in FIG. 5, which presents a drawing illustrating example diagrams of syntactic structure 510, semantic structure 512, and coreference structure 514 found in a script about photography. Notably, in syntactic structure 510, the word ‘key’ depends on the word ‘element’ through an ‘amod’ (adjective modifier) relationship.

Within Crosspower, the descriptive relationships indicated by the syntactic structures can describe the properties and relationships among the corresponding graphics elements. Through the syntactic structure, Crosspower can also extract the conjunction structure by extracting elements that are connected through a ‘conj’ (conjunction) relationship.

Semantic structures (such as semantic structure 512) describe the relationships between words by analyzing their meaning. While semantics are easy for humans to understand, determining the semantics of a simple sentence is a challenging task for an NLP technique. Given the large vocabulary and infinite combinations of words that can be created using, e.g., the English language, a common computational approach to extract meaning from a phrase or sentence is to examine the semantic roles of the linguistic elements in the sentence. In the sentence, “Let us begin with the subject”, a semantic relation between us, begin, and with the subject can be extracted (e.g., begin (us, with the subject)) such that “begin” is the action or verb, and “us” and “with the subject” are semantic arguments of the action. The roles of the semantic arguments are also indicated with ‘a0’ assigned to arguments that are agents or causers of the action, and ‘arg1’ assigned to the patient or receiver of the action.

Semantic structures can not only be indicated by verbs, but also nouns and prepositions. The variety of semantic structures that are possible within a sentence can also result in hierarchical structures where the argument of one semantic structure can contain other semantic structures (such as semantic structure 512). The process of determining semantic roles is called Semantic Role Labelling and can be reliably performed using NLP toolkits.

Semantic structures may be used in Crosspower because they indicate semantic relationships that are often represented graphically in content, such as videos, animations, and/or presentations. By providing the graphics counterparts for the constituents of a semantic structure, and organizing them based at least in part on the semantics, Crosspower may enable users to easily create desired layouts or animations.

Understanding the flow of semantics across sentences may require identification of coreference, which may occur when multiple expressions in language refer to the same entity, either by explicitly using pronouns or by implicitly being inferred based on the context. FIG. 5 shows an example in which the multiple mentions of subject and it refer to the same entity. Coreference structure 514 (which is sometimes referred to as ‘coreference resolution’) is the task of identifying words or phrases that refer to the same entity, which can be performed by NLP toolkits.

Within the context of Crosspower, coreference structures can indicate whether the transformations and animations corresponding to the semantics can be referred to using the same graphics elements, thereby enabling users to quickly create a sequence of graphics effects.

In addition to the structures that are implicitly embedded among the order and semantics of words, writing typically make use of explicit organizational structures and rule sets to convey intent and meaning. For example, the use of paragraphs, sections, and headings allow writing to be organized thematically, enable argumentation, enhance connectivity and flow, and provide clear visual organizations. Phrases and sentences can also be organized into lists to convey the sequential or parallel relationship amongst list items.

Within Crosspower, the extraction and utilization of such organizational structures may be used with linguistic structures to ensure that users can consistently interact with the various structures in language.

### Developing a Language-Driven Grammar:

Crosspower uses an explicit language-driven grammar to specify the corresponding graphics representations of linguistic structures. In the linguistic structures, syntactic and semantic structures may suggest graphics components as well as their appearance, layout, and animation relationships among various linguistic elements. For each constituent of a syntactic and semantic structure, the grammar may specify the content and form of the corresponding graphics element, with the semantics encoded in the appearance, spatial arrangements, and/or behaviors of the graphics elements. Moreover, coreference structures may allow a user to specify whether different semantic arguments refer to the same graphics element.

### Specification of Content:

A semantic structure may indicate multiple possible operations on graphics elements based at least in part on the semantics and context, including: the need for new graphics elements; the transformation of existing elements; and/or the removal of existing elements.

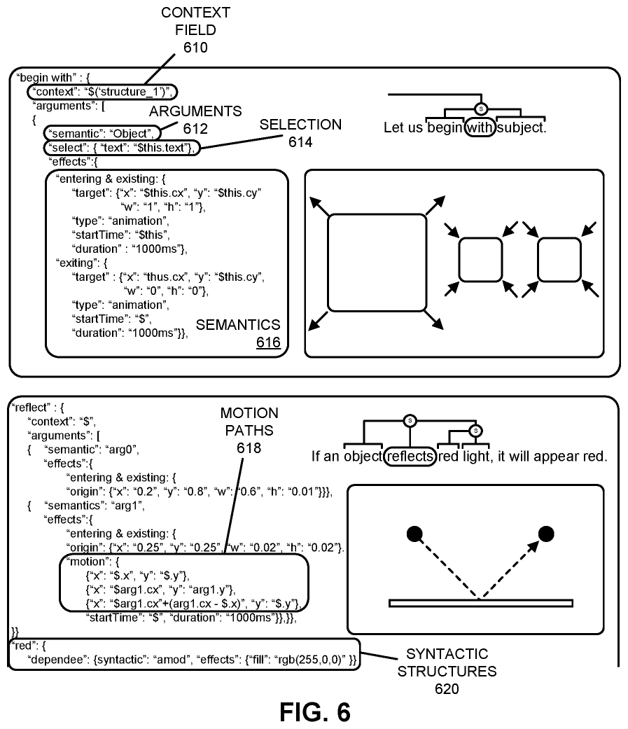

For example, the “begin with” semantic structure may indicate the need for a new graphics element. However, if it has already been mentioned, the user may instead want to perform an action using this element, such as highlighting an existing image. In order to address this ambiguity, the grammar uses a context input field to describe the scope of elements that the grammar operates on. This is illustrated in FIG. 6, which shows an example of a language-driven grammar, including: a context field 610 allows a user to interactively compose structures; arguments 612 may be identified based at least in part on their semantic roles; selection 614 operations based at least in part on context separate entering, existing, and exiting elements; semantics 616 may be reflected using graphics effects; motion paths 618 for animations may be specified; and/or syntactic structures 620 may be specified. Note that Crosspower may allow users to adjust context 610 input using lightweight interactions to achieve their desired graphics effects.

When the grammar of a semantic structure is applied (such as arguments 612), Crosspower may compare the elements appearing in the arguments with those in context field 610 by matching their characters and separating the elements into one of at least three categories (such as selection 614), including: entering elements, e.g., elements that appear in the structure but not in the context; existing elements, e.g., elements in the context that are referred to in the structure; and/or exiting elements, e.g., elements that are in the context but not referred in the structure.

For a given category, the grammar may further specify the graphics effects based at least in part on the semantics of the structure. For example, a “begin with” phrase may suggest the highlighting of the entering or existing element, and optionally the blur of the exiting elements as well.

### Specification of Graphics Effects and Behaviors:

The grammar may also specify how the layouts and animations of the graphics element should represent the semantics. For example, a highlight or zoom-in effect on an image can represent the transitional action indicated by “begin with” (such as semantics 616). For the sentence, “Language is the foundation of civilization”, a potential visual representation of the foundation relationship between language and civilization may be an image of language underneath the image of civilization to visualize that one is supporting the other.

The grammar may support the specification of numerical graphics attributes including: position (x, y), size (width, height), motion path, opacity, and/or attributes for animations (such as the animated graphics properties, their begin and end values, the start time and/or the duration of the animation). It may also allow the attributes of other graphics and language elements to be referenced. This may reduce the need to manually adjust graphics elements with respect to others. For example, in FIG. 3, motion path 618 for “reflect” is described using the position attributes of the related elements, eliminating the need for the manual adjustment of the motion path when the user changes the position of the related objects.

Syntactic structures often describe other attributes of graphics elements, in addition to their layout and animation. For example, in the phrase, “if an object reflects red light”, the word red modifies the color of the corresponding graphics element. As with semantic 616 structures, the grammar may also specify corresponding graphics effects or behaviors for each constituent of a syntactic structure (such as syntactic structures 620).

Interacting with Language and Graphics:

Note that Crosspower may provide a set of interaction techniques that allows users to quickly navigate, select, modify, and/or connect the linguistic and organizational structures.

### Organizing, Representing, and Navigating Structures:

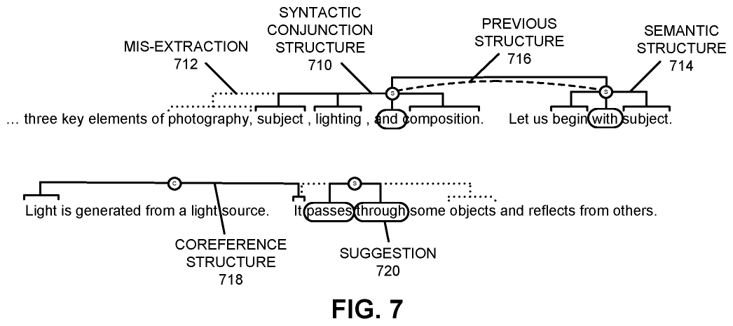

Each word in a language may be associated with many linguistic and organization structures, but not all of them may indicate meaningful graphics representations. Whenever a user hovers over a word when interacting with a user interface (such as a keypad, a mouse, a keyboard, a trackball, a stylus, a touch-sensitive display, a motion-sensitive device, a voice-recognition interface, and/or another user-interface device), Crosspower may extract the linguistic and organizational structures that contain the word and may organize them based at least in part on their hierarchical level, e.g., organizational structures, coreference structures, semantic structures, syntactic structures, and/or the word itself. Then, Crosspower may suggest suitable structures to indicate the corresponding graphics structure. Moreover, Crosspower may prioritize semantic structures, as they often indicate meaningful relationships that can be represented graphically. This is shown in FIG. 7, which presents a drawing illustrating an example of suggested structures in language, including: a syntactic conjunction structure 710, where mis-extraction 712 of the syntactic structure can be fixed by removing an unwanted element; a semantic structure 714 with its semantic arguments; the use of a previous structure 716 as context by connecting two structures; and/or a coreference structure 718. Furthermore, Crosspower may suggest 720 a suitable structure as the user hovers over the words. For example, an icon on top of each structure indicates a type of structure, with ‘S’ indicating both syntactic and semantic structures and ‘C’ indicating coreference structures.

The user may also navigate through the different hierarchical levels to find the one that suits their needs. When the user selects the currently shown structure, Crosspower will add the corresponding graphics layout or animation to the canvas.

Additionally, Crosspower may allow users to compose language structures to quickly create complicated graphics effects. For example, the user can draw a connection between two structures to indicate that the elements mentioned in the previous structure will serve as the context for the grammar within the next structure. Corresponding changes in the graphics representation will then be automatically applied.

In some embodiments, the user may adjust the arguments used in the creation of graphics content. This may be useful if the user does not wish to visualize all the related elements in the structure or if the user needs to fix structure extraction errors. In order to achieve this, the user can remove existing connections or may create new connections between the structure to the elements (such as mis-extraction 712). These structural changes to the text may automatically propagate to the corresponding graphics element and vice versa.

In embodiments where an NLP toolkit fails to recognize coreference structures that users wish to leverage, Crosspower may allow users to connect linguistic elements to create new coreference structures to add graphics effects to existing elements (instead of creating new ones).

Once the user confirms that they want to visualize certain structures, a default graphics representation may be added to the canvas. For entering elements, Crosspower may use an image search query, such as the Google Image Search (from Alphabet, Inc., of Mountainview, California), to query images with corresponding text as the query, and may display the first returned image on the canvas. In some embodiments, the user may want to select a different image and Crosspower may allow the user to browse some or all of the returned search results in-situ, without context switching. The user may also change the search query of a given graphics element to query new sets of images.

If a user wishes to adjust their search by constraining queries with the same new keywords (if they are related to the same domain or concept), Crosspower may enable the user to propagate the addition or removal of keywords to some or all the structured elements to consistently apply the adjustment.

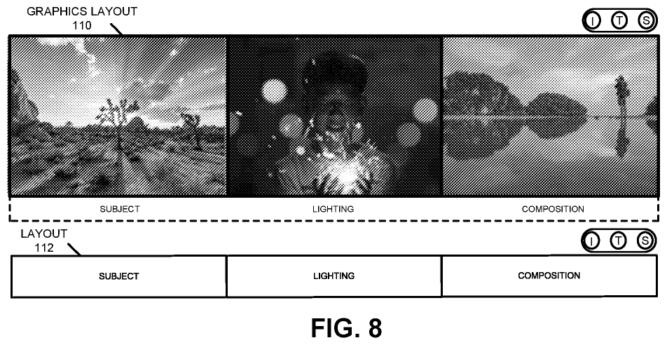

Note that the user may wish to use various graphics elements, such as image, shapes, and/or text, to represent underlying concepts. Crosspower may allow the users to flexibly combine and replace graphics representations to match their own design aesthetics. For example, the user may select the graphics structure and then toggle among the different representations to switch the representation or to select and combine multiple representations. This is shown in FIG. 8, which presents an example of flexible composition of graphical representation in accordance with an embodiment of the present disclosure. Notably, with the same language-grammar, the user can combine images, text, and/or shapes to create different graphic effects. These capabilities may allow users to quickly experiment with different visual effects using different graphics representations. In some embodiments, there may be multiple graphics effects associated with one linguistic structure. Crosspower may display some or all of the other graphics effects to, e.g., the right of the interface, so that the user can browse and select the one that suits their needs.

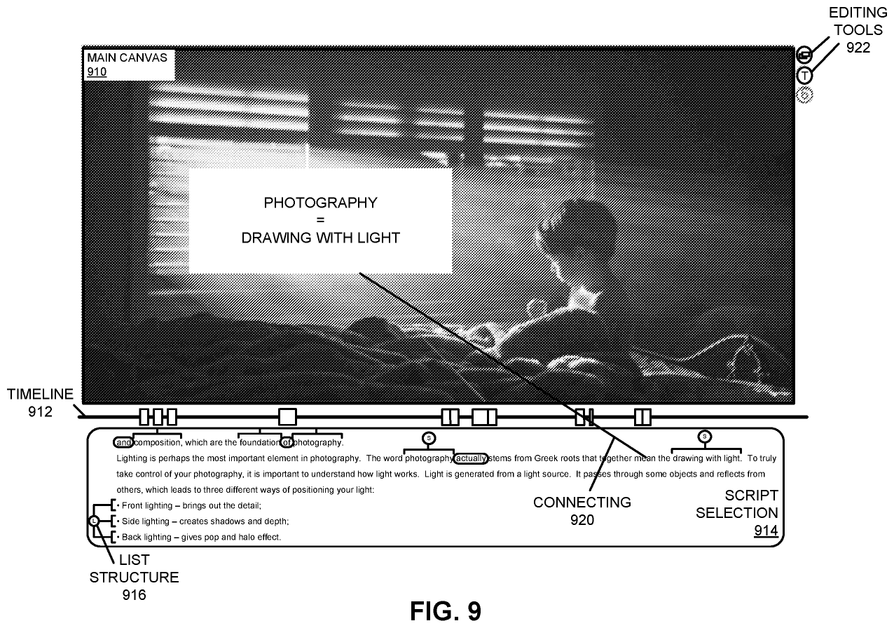

Users often visualize text in a script directly on the canvas to highlight important messages, communicate inherent textual information, and/or for labelling purposes. In order to support such needs, Crosspower may enable users to select text and to transform it into self-defined linguistic structures. The use of these structures may automatically create text elements on the canvas. With a time-aligned script, Crosspower may automatically create a ‘text revealing’ animation in which a given word may appear the moment it is narrated in a video. Similarly, Crosspower may support users in directly converting text lists in a script to graphics lists, where a given list item appears based at least in part on the timing in a narration. This is shown in FIG. 9, which presents a drawing illustrating an example of a user interface, including: a main canvas 910; a timeline 912 with a set of added animation; script section 914; a list structure 916 being used to create a graphics list; connecting 920 a graphic element to a linguistic element; and/or basic editing tools 922.

In embodiments where none of the provided graphics styles suits a user's needs or the user wishes to begin with their own creations, they may manually create a desired style using the basic editing tools 922 or operations provided with Crosspower, such as: adding new images and text to the canvas; or configuring their size, position, and/or animations.

Once a graphics effect is created, the user may connect 920 the graphics object with its corresponding language element in the script. This may allow the user to align the timing of the animation to the narration, but may also allow Crosspower to extract spatial layouts and/or animation properties to form a new graphics representation for the underlying linguistic structure.

In order to demonstrate the utility of Crosspower, consider an example workflow by following Hayley, a professional photographer and YouTuber, who regularly creates and posts videos. Today, she is starting to work on a video that introduces basic concepts in photography.

As always, Hayley first works on her video script to determine the content she will cover in her video. Once her script is completed, she then records a voice-over of the script and begins to create graphics content using Crosspower.

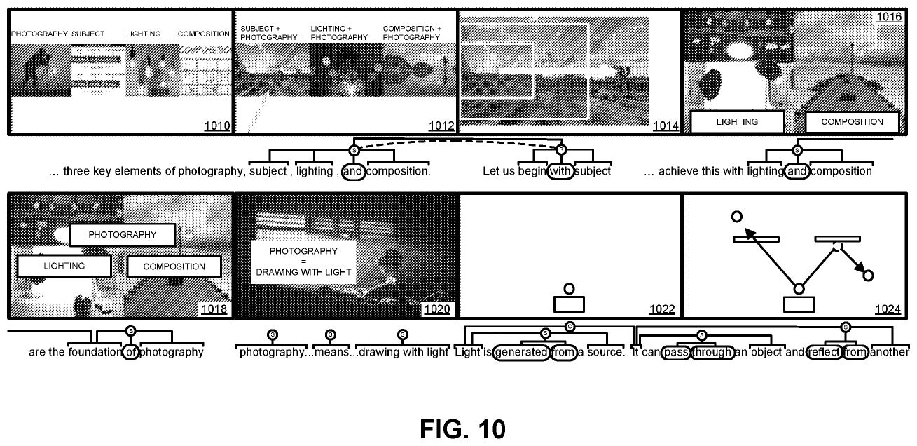

“I will talk about three key elements of photography, subjects, lighting, and composition.” For this opening sentence, she would like to have an overview animation that shows a representative image for each element, one by one. She can directly create corresponding graphics elements and their effects by leveraging the conjunction structure in the text. However, as shown in FIG. 10, which presents a drawing illustrating an example workflow, the underlying dependency parser makes an error and incorrectly extracts “photography” as one of the elements in the structure (operation 1010). She may simply cross the word “photography” out in the structure and the graphics elements may be automatically adjusted. Crosspower may use the text of the elements as search queries to automatically find images online. However, the returned images may not be ideal and she may realize that she needs to constrain the queries, so she may drag and drop the word “photography” from the script to the canvas to use it as an additional search keyword (operation 1012).

“Let's begin with subject.” Here, Hayley wants an expansion animation of the subject image. She can directly select the animation indicated by “begin with” using Crosspower. The computer system then creates a grow animation for a new image element. This is because the underlying NLP toolkit may fail to recognize the coreference of “subject”. She can easily fix this error by indicating that the previous conjunction structure should be used as the context for “begin with”. This not only allows for the creation of the “subject” grow effect, but also the shrink effect of the other element (operation 1014). Note that shape and text may be used to represent the structure (operation 1016).

“You can achieve this with lighting and composition, which are the foundation of photography.” Here, she can create an effect where lighting and composition are represented in rectangular textboxes underneath the photography textbox, representing the concept of foundation. A coreference structure may also need to be created between “lighting and composition” and “foundation” (operation 1018).

“The word photography actually stems from Greek roots that mean drawing with light.” Here, she would like to create a text effect with “photography” and “drawing with light”, where the words reveal themselves one by one. She then selects the text and creates the corresponding graphics text elements. She can also manually create a “=” text element on the canvas and map it to “mean” in the script to leverage its temporal information (operation 1020).

“Light is generated from a light source. It passes through some objects and reflects from others.” Here, a sequence of animations indicated by “generate”, “pass”, and “reflect” can be chained together thanks to their coreference structures and the predefined animations associated to the semantic structures. She can also further customize the motion paths associated with these animations (operation 1022).

Furthermore, an animation is created using the “pass through,” “reflect from” structures, and the coreference structure between “light” and “it” (operation 1024).

The preceding example illustrates how a user can directly select, define, navigate, modify, and combine various linguistic structures to quickly create corresponding graphics effects. This supports a user in expressing high-level design goals rather than performing tedious low-level operations.

In order to validate that extending direct manipulation to structures in language and leveraging the correspondences between graphics and linguistics can enable the flexible and direct creation of graphics content, and to gain feedback about the usefulness and effectiveness of the interactive graphics techniques used in Crosspower, an expert evaluation study was conducted.

Six professional video, animation, and presentation creators were recruited online to evaluate Crosspower in a remote-participation study (2 female, aged 28-42 years). All participants have experience creating videos, animation, or presentations for at least seven years. Participants were requested to provide their professional evaluation on whether and how Crosspower will be useful for their content creation process. Participants received nominal financial compensation for their evaluations.

In order to facilitate remote participation, Crosspower was run on a computer system that participants were able to directly interact with through TeamViewer (from TeamViewer AG, of Göppingen, Germany). Video conferencing was used to communicate with participants.

### Example 1: Procedure

Each expert review session included the following phases:

Introduction and Training (25 minutes). The experiment first introduced the underlying concepts of Crosspower. Then, the experimenter performed the interaction techniques and described them verbally. Participants were then asked to perform the interaction techniques and seek help when necessary.

Creation Exercise (20 minutes). The participants were then asked to create and iterate on the graphics content for a 205-word script provided by the experimenter, which lent itself to many of the implemented interactive graphics techniques. This task was designed to ensure that participants got enough practice using Crosspower and for the research team to observe their learning process.

Freeform Exploration (20 minutes). Participants were then asked to create the graphics content for a segment of a video or presentation script (200-250 words) that they had previously used, which the experimenter requested them to bring to the study.

Questionnaire and Exit Interview (20 minutes). Participants then completed a questionnaire about Crosspower, probing the usefulness and usability of the interaction techniques using a 7-point Likert scale (1—Strongly Disagree, 7—Strongly Agree). Next, the experimenter conducted a semi-structured interview to further collect feedback about the utility of the interaction techniques and the workflow when using Crosspower.

We report on the results of the expert evaluation pertaining to the utility of language structures, the new workflows enabled by Crosspower, and suitable content domains.

### Utility of Language Structures

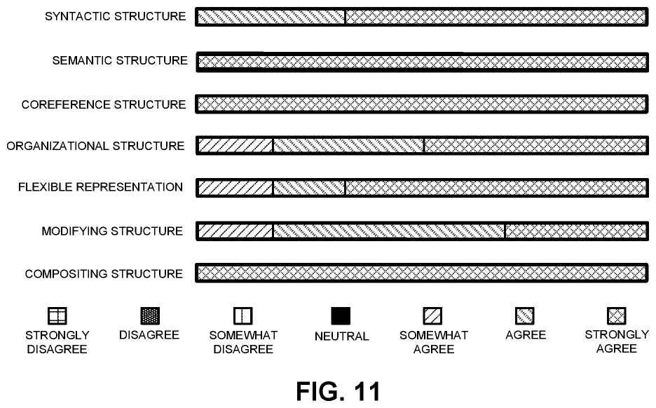

Participants were asked to rate the usefulness of each of the techniques. This is shown in FIG. 11, which presents a drawing illustrating feedback responses from participants (such as Likert responses). The results indicated that the various techniques to interact with the language structures were useful and desirable. All participants responded positively that the use of language structures allowed them to quickly (4/6 strongly agree, 2/6 agree) and flexibly (4/6 strongly agree, 2/6 agree) create graphics content.

Participants also responded favorably to the composition of language structures, as they removed the “painful work” (Participant 4) and allowed them to “quickly build something pretty complex” (Participant 5). Being able to modify structures, as well as select and combine different representations, was also preferred by participants as it enabled “control over the provided templates” (Participant 2).

Language Structures Vs. Existing Practices

Participants found that “the use of language structures fits my prior workflows of creating graphics content (e.g., video, animation, or presentation)” (6—strongly agree). “The content and message are most important” (Participant 1), and it is important to “make sure graphics match the content” (Participant 3), as “you want to use the graphics to help the audience to understand the content not to confuse them” (Participant 3).

Leveraging language structures also enabled new workflows, where participants were able to focus on exploring what content they wanted to represent graphically rather than on how to create the graphics, e.g., “I felt like I was mostly focusing on the script and less on how to make the effects, but still I was able to create good effects at the end” (Participant 5) and “you can quickly throw together a decent deck of slides with this” (Participant 1).

Participants acknowledged the strength of encapsulating several animations into a language structure, e.g., “the animations provided in most existing tools are very basic . . . you need to know the big transition you want, and then figure out how to achieve that with the basic animations . . . and this is not easy, especially when I first started [in this domain]” (Participant 1). With Crosspower, they could directly see the potential animations that “represent the messages” (Participant 5). Moreover, participants perceived the language structures as a suitable way to organize or index the templates “when I search templates, I need to use exact names of the effects to get good results, but sometimes I don't know what effects are good, it would be great if I can search with the content itself and see what's out there” (Participant 2).

When asked to compare language-driven templates to other templates they have used, participants appreciated the ability to modify the underlying language structure to adjust the graphics templates, as the “adaptable templates” allowed them to “easily turn the templates into what I [they] want” (Participant 4). In comparison, they often need to “do a lot of tweaks for the templates I [they] got online” (Participant 4).

### Suitable Domains

Participants suggested several types of graphics content that could be easily created with Crosspower, including technical presentations and informational videos (e.g., explainer videos, video essays, or infographic videos), which often use animation and graphics to facilitate content comprehension and can benefit from the correspondence between linguistics and graphics.

Participants also commented that content that is either too formal or informal may not be well suited for Crosspower. Formal content such as motion graphics often requires precise specification and is “more to dazzle the audience” (Participant 5) rather than communicating meaningful information. On the other hand, creative and artistic expressions, such as inspirational talks or poetry, often consist of abstract, ambiguous, or emotional words and phrases that may not have direct linguistic-graphics correspondences and be better accompanied by specific and well-chosen images (Participant 1).

The results from the expert evaluation show that leveraging the linguistic-graphics mappings may reduce the manual effort encountered when creating graphics content, but also suggest limitations and opportunities for improvement.

### Erroneous Natural Language Processing

Crosspower builds upon linguistic structures provided by NLP toolkits, which contain errors occasionally, including failing to extract semantic and coreference structures, erroneous syntactic and/or semantic parsing. Crosspower does not support the correction of parsing errors or the specification of missing semantic structures. All participants felt confused when encountering such errors and had to resort to manual creation. While we expect the mitigation of such problems as NLP techniques become increasingly powerful, an alternative might be to enable users to specify desired changes that can be propagated to underlying NLP modules for error correction.

### Complex Linguistic Structures

Similar confusion was also found when participants were shown complicated semantic structures that contain multiple hierarchical levels or many semantic arguments, when they were only interested in parts of structures. Participants commented that they were overwhelmed by the complexity (Participant 1, Participant 3), and had to spend time understanding the structures and deciding how to utilize them. This is perhaps because the linguistic structures provided by NLP toolkits do not directly match the expectations of users. This may be addressed by progressively disclosing the semantic structures and arguments based at least in part on context and in a representation that matches the mental models of a user.

The expert evaluation demonstrates considerable promise of language-oriented authoring. In some embodiments, Crosspower may be applied to graphics content of different types with users of different levels of expertise.

### Example 2: Potential Application: A Universal Linguistic-Graphics Dictionary

In some embodiments, the capabilities of Crosspower may be extended by collecting a large amount of language-driven graphics effects. A repository of graphics effects may increase the expressive power of Crosspower, but may also allow for the further exploration of how to suggest the most suitable graphics effect for a language structure that fits into a holistic visual style. This collected repository may also contribute to efforts to construct a complete a linguistic-graphics dictionary. Existing efforts focused on the construction between nouns to images of real-world objects, whereas in some embodiments Crosspower focuses on the dynamic graphics actions mostly indicated by verbs. Today, an increasing number of graphics-rich videos such as explainer and infographic videos are published online, which use graphics, animations, and narration to explain concepts with a compelling storytelling experience. These videos contain rich linguistic-graphics mappings that may be collected and shared with the community.

### Example 3: Potential Application: Interactive Scripting Graphics Content

Crosspower may or may not support the interactive experimentation between linguistic and graphics structures. While a user is free to edit the natural language input and interact with the linguistic structures, in some embodiments Crosspower may not be able to provide the desired graphics effects. However, in other embodiments, these capabilities may be included by increasing the number of predefined linguistic-graphics mappings. A rich linguistic-graphics dictionary may allow us to provide the interactive creation and modification of both linguistic and graphics content. This may enable new ways of creating graphics content as the users dynamically experiment with both the linguistic and graphics expression. It may also allow the combination of explicit scripts or markup languages together with natural language input to enable for the quick and flexile composition of graphics content.

### Example 4: Potential Application: From Written to Spoken Language

While some embodiments of Crosspower focus on leveraging structures in written language, the use of linguistic structures may also be directly applied to spoken language. This can be useful for generating visual aids during conversations in augmented reality, virtual reality, translation services, video games, generated content (such as video and/or audio generated using a neural network) or other forms of shared displays. Besides rich linguistic structures, spoken language uses acoustic signals such as pitch, tone, and stress to convey meaning and sentiment, which could be useful to infer graphics styles.

### Example 5: Potential Application: Challenges with Creative and Artistic Expression

While linguistic-graphics mappings allow content creators to articulate high-level design goals, they may not be abstracted enough for creative and artistic language expressions, which often consist of words and phrases that are abstract, ambiguous, or emotional. Such high-level semantics often do not have clear and direct graphics correspondences and may require creative composition of graphics effects. In some embodiments, Crosspower may identify, distill, and leverage such higher-level design knowledge and creativity to facilitate the design of compelling graphics content. The disclosed interactive graphics techniques are based at least in part on a systematic exploration of language-oriented authoring, which bridges linguistics with graphics through the identification, graphics specification, and/or interaction of various structures in written language. Crosspower may enable users to directly navigate, select, modify, and/or compose linguistic structures to indicate high-level design goals rather than forcing users to perform tedious low-level editing operations. As demonstrated through expert evaluation, Crosspower may enable content creators to create and customize graphics content directly and flexibly.

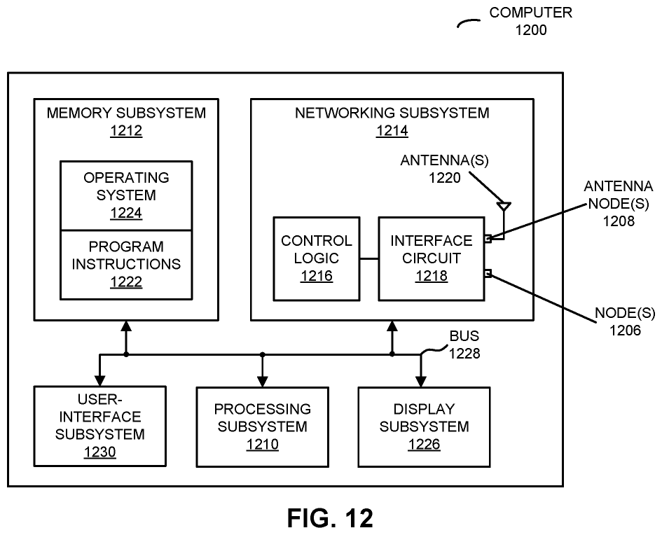

We now describe embodiments of a computer, which may perform at least some of the operations in the interactive graphics techniques. FIG. 12 presents a block diagram illustrating an example of a computer 1200, e.g., in a computer system (such as computer system 200 in FIG. 2), in accordance with some embodiments. For example, computer 1200 may include: one of computers 210. This computer may include processing subsystem 1210, memory subsystem 1212, and networking subsystem 1214. Processing subsystem 1210 includes one or more devices configured to perform computational operations. For example, processing subsystem 1210 can include one or more microprocessors, ASICs, microcontrollers, programmable-logic devices, GPUs and/or one or more DSPs. Note that a given component in processing subsystem 1210 are sometimes referred to as a ‘computation device’.

Memory subsystem 1212 includes one or more devices for storing data and/or instructions for processing subsystem 1210 and networking subsystem 1214. For example, memory subsystem 1212 can include dynamic random access memory (DRAM), static random access memory (SRAM), and/or other types of memory. In some embodiments, instructions for processing subsystem 1210 in memory subsystem 1212 include: program instructions or sets of instructions (such as program instructions 1222 or operating system 1224), which may be executed by processing subsystem 1210. Note that the one or more computer programs or program instructions may constitute a computer-program mechanism. Moreover, instructions in the various program instructions in memory subsystem 1212 may be implemented in: a high-level procedural language, an object-oriented programming language, and/or in an assembly or machine language. Furthermore, the programming language may be compiled or interpreted, e.g., configurable or configured (which may be used interchangeably in this discussion), to be executed by processing subsystem 1210.

In addition, memory subsystem 1212 can include mechanisms for controlling access to the memory. In some embodiments, memory subsystem 1212 includes a memory hierarchy that comprises one or more caches coupled to a memory in computer 1200. In some of these embodiments, one or more of the caches is located in processing subsystem 1210.

In some embodiments, memory subsystem 1212 is coupled to one or more high-capacity mass-storage devices (not shown). For example, memory subsystem 1212 can be coupled to a magnetic or optical drive, a solid-state drive, or another type of mass-storage device. In these embodiments, memory subsystem 1212 can be used by computer 1200 as fast-access storage for often-used data, while the mass-storage device is used to store less frequently used data.

Networking subsystem 1214 includes one or more devices configured to couple to and communicate on a wired and/or wireless network (i.e., to perform network operations), including: control logic 1216, an interface circuit 1218 and one or more antennas 1220 (or antenna elements). (While FIG. 12 includes one or more antennas 1220, in some embodiments computer 1200 includes one or more nodes, such as antenna nodes 1208, e.g., a metal pad or a connector, which can be coupled to the one or more antennas 1220, or nodes 1206, which can be coupled to a wired or optical connection or link. Thus, computer 1200 may or may not include the one or more antennas 1220. Note that the one or more nodes 1206 and/or antenna nodes 1208 may constitute input(s) to and/or output(s) from computer 1200.) For example, networking subsystem 1214 can include a Bluetooth™ networking system, a cellular networking system (e.g., a 3G/4G/5G network such as UMTS, LTE, etc.), a universal serial bus (USB) networking system, a networking system based on the standards described in IEEE 802.11 (e.g., a Wi-Fi® networking system), an Ethernet networking system, and/or another networking system.

Networking subsystem 1214 includes processors, controllers, radios/antennas, sockets/plugs, and/or other devices used for coupling to, communicating on, and handling data and events for each supported networking system. Note that mechanisms used for coupling to, communicating on, and handling data and events on the network for each network system are sometimes collectively referred to as a ‘network interface’ for the network system. Moreover, in some embodiments a ‘network’ or a ‘connection’ between the electronic devices does not yet exist. Therefore, computer 1200 may use the mechanisms in networking subsystem 1214 for performing simple wireless communication between electronic devices, e.g., transmitting advertising or beacon frames and/or scanning for advertising frames transmitted by other electronic devices.

Within computer 1200, processing subsystem 1210, memory subsystem 1212, and networking subsystem 1214 are coupled together using bus 1228. Bus 1228 may include an electrical, optical, and/or electro-optical connection that the subsystems can use to communicate commands and data among one another. Although only one bus 1228 is shown for clarity, different embodiments can include a different number or configuration of electrical, optical, and/or electro-optical connections among the subsystems.

In some embodiments, computer 1200 includes a display subsystem 1226 for displaying information on a display, which may include a display driver and the display, such as a liquid-crystal display, a multi-touch touchscreen, etc. Moreover, computer 1200 may include a user-interface subsystem 1230, such as: a mouse, a keyboard, a trackpad, a stylus, a voice-recognition interface, and/or another human-machine interface.

Computer 1200 can be (or can be included in) any electronic device with at least one network interface. For example, computer 1200 can be (or can be included in): a desktop computer, a laptop computer, a subnotebook/netbook, a server, a supercomputer, a tablet computer, a smartphone, a cellular telephone, a consumer-electronic device, a portable computing device, communication equipment, and/or another electronic device.

Although specific components are used to describe computer 1200, in alternative embodiments, different components and/or subsystems may be present in computer 1200. For example, computer 1200 may include one or more additional processing subsystems, memory subsystems, networking subsystems, and/or display subsystems. Additionally, one or more of the subsystems may not be present in computer 1200. Moreover, in some embodiments, computer 1200 may include one or more additional subsystems that are not shown in FIG. 12. Also, although separate subsystems are shown in FIG. 12, in some embodiments some or all of a given subsystem or component can be integrated into one or more of the other subsystems or component(s) in computer 1200. For example, in some embodiments program instructions 1222 are included in operating system 1224 and/or control logic 1216 is included in interface circuit 1218.

Moreover, the circuits and components in computer 1200 may be implemented using any combination of analog and/or digital circuitry, including: bipolar, PMOS and/or NMOS gates or transistors. Furthermore, signals in these embodiments may include digital signals that have approximately discrete values and/or analog signals that have continuous values. Additionally, components and circuits may be single-ended or differential, and power supplies may be unipolar or bipolar.

An integrated circuit may implement some or all of the functionality of networking subsystem 1214 and/or computer 1200. The integrated circuit may include hardware and/or software mechanisms that are used for transmitting signals from computer 1200 and receiving signals at computer 1200 from other electronic devices. Aside from the mechanisms herein described, radios are generally known in the art and hence are not described in detail. In general, networking subsystem 1214 and/or the integrated circuit may include one or more radios.

In some embodiments, an output of a process for designing the integrated circuit, or a portion of the integrated circuit, which includes one or more of the circuits described herein may be a computer-readable medium such as, for example, a magnetic tape or an optical or magnetic disk or solid state disk. The computer-readable medium may be encoded with data structures or other information describing circuitry that may be physically instantiated as the integrated circuit or the portion of the integrated circuit. Although various formats may be used for such encoding, these data structures are commonly written in: Caltech Intermediate Format (CIF), Calma GDS II Stream Format (GDSII), Electronic Design Interchange Format (EDIF), OpenAccess (OA), or Open Artwork System Interchange Standard (OASIS). Those of skill in the art of integrated circuit design can develop such data structures from schematics of the type detailed above and the corresponding descriptions and encode the data structures on the computer-readable medium. Those of skill in the art of integrated circuit fabrication can use such encoded data to fabricate integrated circuits that include one or more of the circuits described herein.

While some of the operations in the preceding embodiments were implemented in hardware or software, in general the operations in the preceding embodiments can be implemented in a wide variety of configurations and architectures. Therefore, some or all of the operations in the preceding embodiments may be performed in hardware, in software or both. For example, at least some of the operations in the interactive graphics techniques may be implemented using program instructions 1222, operating system 1224 (such as a driver for interface circuit 1218) or in firmware in interface circuit 1218. Thus, the interactive graphics techniques may be implemented at runtime of program instructions 1222. Alternatively or additionally, at least some of the operations in the interactive graphics techniques may be implemented in a physical layer, such as hardware in interface circuit 1218.

In the preceding description, we refer to ‘some embodiments’. Note that ‘some embodiments’ describes a subset of all of the possible embodiments, but does not always specify the same subset of embodiments. Moreover, note that the numerical values provided are intended as illustrations of the interactive graphics techniques. In other embodiments, the numerical values can be modified or changed.

The foregoing description is intended to enable any person skilled in the art to make and use the disclosure, and is provided in the context of a particular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein may be applied to other embodiments and applications without departing from the spirit and scope of the present disclosure. Additionally, the discussion of the preceding embodiments is not intended to limit the present disclosure. Thus, the present disclosure is not intended to be limited to the embodiments shown, but is to be accorded the widest scope consistent with the principles and features disclosed herein.

1. A computer system, comprising:
a computation device;
memory configured to store program instructions, wherein, when executed by the computation device, the program instructions cause the computer system to perform one or more operations comprising:
receiving text or information specifying an amount of spoken language;
extracting, using natural language processing (NLP), linguistic structures associated with the text or the amount of spoken language;
determining mappings between the linguistic structures and graphics content based at least in part on a predefined grammar, wherein the predefined grammar specifies a target context for matching to arguments associated with the linguistic structures, and specifies one or more corresponding graphics elements having one or more associated: appearances, layouts or graphics effects; and
generating the graphics content associated with the text or the amount of spoken language, wherein the graphics content comprises a graphics element having one or more of: an appearance, a layout, or a graphics effect.

2. The computer system of claim 1, wherein the mappings are determined based at least in part on user-specified mappings between the linguistic structures and the graphics.

3. The computer system of claim 2, wherein the operations comprise receiving user-interface activity specifying the user-specified mappings; and
wherein the user-interface activity corresponds to dynamic interaction, via a user interface, of a user with at least a subset of the linguistic structures, at least a subset of the graphics, or both to specify at least a subset of the graphics content.

4. The computer system of claim 1, wherein the operations comprise:
performing a search for the one or more graphics elements based at least in part on a search query corresponding to the user-interface activity, the determined linguistic structures or both.

5. The computer system of claim 4, wherein the search comprises an image search.

6. The computer system of claim 1, wherein the operations comprise providing a presentation with the text or the amount of spoken language and the graphics content.

7. The computer system of claim 1, wherein the NLP comprises a pretrained: neural network, or a machine-learning model.

8. The computer system of claim 1, wherein the linguistic structures comprise: a syntactic structure that specifies a rule governing an order of words; a semantic structure that specifies a meaning or interpretation of one or more of the words, a phrase the comprises one or more of the words, or a sentence that comprises one or more of the words; a coreference that indicates multiple words or phrases corresponding to a common entity; or an organizational list specifying a paragraph, a section, a heading, or a list.

9. The computer system of claim 8, wherein the syntactic structure comprises dependencies or relationships among the words.

10. The computer system of claim 8, wherein organization of one or more of the graphics elements is based at least in part on the semantic structure.

11. The computer system of claim 8, wherein the semantic structure specifies the appearance, the layout or the graphic effect of the graphics element.

12. The computer system of claim 11, wherein the graphics element is an added graphics element or a modified graphics element in the graphics content.

13. The computer system of claim 8, wherein the semantic structure specifies removal of a second graphics element from the graphics content.

14. The computer system of claim 8, wherein a common graphics element is associated with the multiple words or phrases for the coreference.

15. The computer system of claim 1, wherein the operations comprise providing a recommendation for one or more graphics elements based at least in part on the user-interface activity.

16. The computer system of claim 1, wherein the user-interface activity comprises connecting a first linguistic structure and a second linguistic structure so that one or more graphics elements associated with the first linguistic structure specify at least a portion of the predefined grammar for the second linguistic structure.

17. A non-transitory computer-readable storage medium for use in conjunction with a computer system, the computer-readable storage medium configured to store program instructions that, when executed by the computer system, causes the computer system to perform one or more operations comprising:
receiving text or information specifying an amount of spoken language;
extracting, using natural language processing (NLP), linguistic structures associated with the text or the amount of spoken language;
determining mappings between the linguistic structures and graphics content based at least in part on a predefined grammar, wherein the predefined grammar specifies a target context for matching to arguments associated with the linguistic structures, and specifies one or more corresponding graphics elements having one or more associated: appearances, layouts, or graphics effects; and
generating the graphics content associated with the text or the amount of spoken language, wherein the graphics content comprises a graphics element having one or more of: an appearance, a layout, or a graphics effect.

18. The non-transitory computer-readable storage medium of claim 17, wherein the linguistic structures comprise: a syntactic structure that specifies a rule governing an order of words; a semantic structure that specifies a meaning or interpretation of one or more of the words, a phrase the comprises one or more of the words, or a sentence that comprises one or more of the words; a coreference that indicates multiple words or phrases corresponding to a common entity; or an organizational list specifying a paragraph, a section or a heading.

19. A method for generating graphics content, comprising:
by a computer system:
receiving text or information specifying an amount of spoken language;
extracting, using natural language processing (NLP), linguistic structures associated with the text or the amount of spoken language;
determining mappings between the linguistic structures and the graphics content based at least in part on a predefined grammar, wherein the predefined grammar specifies a target context for matching to arguments associated with the linguistic structures, and specifies one or more corresponding graphics elements having one or more associated: appearances, layouts, or graphics effects; and
generating the graphics content associated with the text or the amount of spoken language, wherein the graphics content comprises a graphics element having one or more of: an appearance, a layout, or a graphics effect.

20. The method of claim 19, wherein the linguistic structures comprise: a syntactic structure that specifies a rule governing an order of words; a semantic structure that specifies a meaning or interpretation of one or more of the words, a phrase the comprises one or more of the words, or a sentence that comprises one or more of the words; a coreference that indicates multiple words or phrases corresponding to a common entity; or an organizational list specifying a paragraph, a section or a heading.
